(19) United States
(12) Patent Application Publication
(10) Pub. No.: US 2019/0124395 A1
(43) Pub. Date: Apr. 25, 2019

(54) IMAGE PROCESSING APPARATUS AND IMAGE DATA PROCESSING METHOD COOPERATING WITH FRAME BUFFER

(71) Applicant: MStar Semiconductor, Inc., Hsinchu Hsien (TW)

(72) Inventor: Jia-Wei LIN, Hsinchu Hsien (TW)

(21) Appl. No.: 15/874,336

(22) Filed: Jan. 18, 2018

(30) Foreign Application Priority Data
Oct. 19, 2017 (TW) 106135859

(51) Int. Cl. H04N 21/44; G06F 12/1027; G06F 12/1009; H04N 21/433; H04N 19/423; H04N 7/14

(52) U.S. Cl. CPC H04N 21/44004; G06F 12/1027; G06F 12/1009; G06F 2212/68; H04N 19/423; H04N 7/147; G06F 2212/65; H04N 21/4331

(57) ABSTRACT

An image processing apparatus includes a frame buffer, a compression circuit, a prediction circuit and a memory management circuit. The frame buffer is configured to include multiple large pages and multiple small pages. The compression circuit compresses image data to generate compressed image data. The prediction circuit generates a predicted data size for the compressed image data. In response to a storage request of storing the compressed image data into the frame buffer, the memory management circuit allocates N number of large pages and M number of small pages to the compressed image data. According to the predicted data size, the memory management circuit determines an order of using the N number of large pages and the M number of small pages when the compressed image data is stored into the frame buffer.

This application claims the benefit of Taiwan application Serial No. 106135859, filed Oct. 19, 2017, the subject matter of which is incorporated herein by reference.

### BACKGROUND OF THE INVENTION

### Field of the Invention

The invention relates to an image processing system, and more particularly to a memory management technology in an image processing system.

### Description of the Related Art

The data size of digital images is usually massive and increases as the resolution gets higher. In applications such as video calls and digital televisions, image data sometimes needs to be transmitted by means of streaming via a wireless network. To prevent the issue of insufficient bandwidth caused by a large data size, a transmitting end encodes image data to reduce the data size before outputting the image data. Correspondingly, a receiving end needs to use a decoder to decode received data to restore original data. Many receiving ends adopt a storage device such as a double data rate synchronous dynamic random access memory (DDR SDRAM) as a frame buffer for buffering restored image data from a decoder for a subsequent image process. Hardware cost of a frame buffer can be significant, making the subject of effectively using a storage space in the frame buffer noteworthy.

FIG. 1(A) shows a partial function block diagram of a digital image receiving end 100. In this example, to enhance the space utilization rate of a frame buffer 16 and to save the transmission bandwidth for data access, image data outputted from a decoder 12 is processed by a compression circuit 14. In other words, image data stored into the frame buffer 16 is compressed image data. Each time a new batch of compressed data is stored into the frame buffer, the compression circuit 14 issues a storage request to a memory management circuit 18. In response to the storage request, the memory management circuit 18 generates a configuration command, and allocates an available space with an appropriate size in the frame buffer 16 to this batch of compressed image data.

Because compressed image data generated is sequentially stored into the frame buffer when the compression circuit 14 performs compression, the memory management circuit 18 needs to send out the configuration command before the compression circuit 14 starts outputting the compressed image data. However, contents in individual images are different, and an actual data size generated by the compression circuit 14 each time is an unknown value to the memory management circuit 18 before the compression circuit 14 completes the compression process. One current approach is that, a possible maximum data size of a batch of image data compressed by the compression circuit 14 is first estimated to serve as the basis of space allocation for the memory management circuit 18. For example, assuming that in a worst scenario the data size generated by the compression circuit 14 is 5 MB, the memory management circuit 18 can allocate a fixed storage space of 5 MB to each batch of compressed image data, so as to ensure sufficient space is provided even for worst possible compression efficiency.

The frame buffer 16 is usually configured to include multiple same-sized pages, and the memory management circuit 18 allocates space in a unit of pages. Assume that the memory management circuit 18 needs to allocate 5 MB storage space to each batch of compressed data. Thus, if the storage capacity of each page is 5 MB, the memory management circuit 18 can allocate one page to a new batch of compressed data each time; if the storage capacity of each page is 1 MB, the memory management circuit 18 can allocate five pages to a new batch of compressed data each time.

If a 5 MB compressed data size is a worst scenario, it implies that the data size of some image data after the compression is lower than 5 MB. FIG. 1(B) shows an example of how pages in the frame buffer 16 are used when the storage capacity of each page is 5 MB. In this example, the data size of compressed image data D2 is close to 5 MB, and so the space in a page P2 is almost completely used up. However, as data sizes of compressed data D1 and D3 are both lower than 5 MB, the spaces in pages P1 and P2 are apparently not fully used. In comparison, FIG. 1(C) shows an example of how pages in the frame buffer 16 are used when the stored data sizes are equal but the storage capacity of each page is 1 MB. After determining that the compressed data D1 takes up the storage space of only four pages, the memory management circuit 18 can retract a page P5 that is not at all used by the compressed image data D1. Similarly, pages P14 and P15 that are not at all used by the compressed image data D3 can be retracted by the memory management circuit 18 and be later allocated to other batches of compressed image data. As such, the unused and wasted space at most does not exceed the storage capacity of one page in FIG. 1(C), i.e., 1 MB.

It is seen from the above examples that, adopting small pages improves the issue of not fully using the storage space. However, compared to large pages, adopting small pages involves page management using more page numbers. Further, under the condition of equal data size to be stored, the number of pages accessed when small pages are adopted is greater and more time-consuming, resulting a negative influence on the overall operating efficiency of a memory. Therefore, there is a need for a solution that adopts pages of an appropriate size so as to attend to both space utilization rate of a frame buffer and operation efficiency.

### SUMMARY OF THE INVENTION

The invention is directed to an image processing apparatus and an image data processing method cooperating with a frame buffer.

According to an embodiment of the present invention, an image processing apparatus includes a frame buffer, a compression circuit, a prediction circuit and a memory management circuit. The frame buffer is configured to include a plurality of large pages and a plurality of small pages. The compression circuit compresses image data to generate compressed image data, and generates a storage request of storing the compressed image data into the frame buffer. In response to the storage request, the prediction circuit generates a predicted data size of the compression image data. In response to the storage request, the memory management circuit allocates N number of large pages and M number of small pages in the frame buffer to the compressed image data, where N and M are individually positive integers. The memory management circuit determines, according to the predicted data size, an order of using the N number of large pages and the M number of small pages when the compressed image data is stored into the frame buffer.

According to another embodiment of the present invention, an image data processing method cooperating with a frame buffer is provided. The frame buffer is configured to include a plurality of large pages and a plurality of small pages. The image data processing method includes: compressing image data to generate compressed image data; generating a storage request of storing the compressed image data into the frame buffer; in response to the storage request, generating a predicted data size of the compressed image data; in response to the storage request, allocating N number of large pages and M number of small pages in the frame buffer to the compressed image data, where N and M are individually positive integers; and determining, according to the predicted data size, an order of using the N number of large pages and the M number of small pages when the compressed image data is stored into the frame buffer.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1(A) (prior art) is a partial function block diagram of a digital image receiving end; FIG. 1(B) (prior art) and FIG. 1(C) (prior art) are examples of using pages in a frame buffer in situations where pages have different storage capacities;

FIG. 2 is a function block diagram of an image processing apparatus according to an embodiment of the present invention;

FIG. 3(A) is a detailed diagram of a memory management circuit according to an embodiment of the present invention; FIG. 3(B) is a schematic diagram of an order of using pages;

FIG. 4(A) is a detailed diagram of a value generating circuit according to an embodiment of the present invention; FIG. 4(B) and FIG. 4(C) are schematic diagrams of two examples of an order of using pages;

FIG. 5(A) is a detailed diagram of a memory management circuit cooperating with pages having three different storage capacities according to an embodiment of the present invention; FIG. 5(B) is a schematic diagram of an example of an order of using pages;

FIG. 6 is a detailed diagram of a memory management circuit cooperating with pages having three different storage capacities according to another embodiment of the present invention;

FIG. 7(A) is detailed diagram of a value generating circuit according to another embodiment of the present invention; FIG. 7(B) is a schematic diagram of an example of an order of using pages;

FIG. 8 is a detailed diagram of a memory management circuit according to an embodiment of the present invention; and

FIG. 9 is a flowchart of an image data processing method according to an embodiment of the present invention.

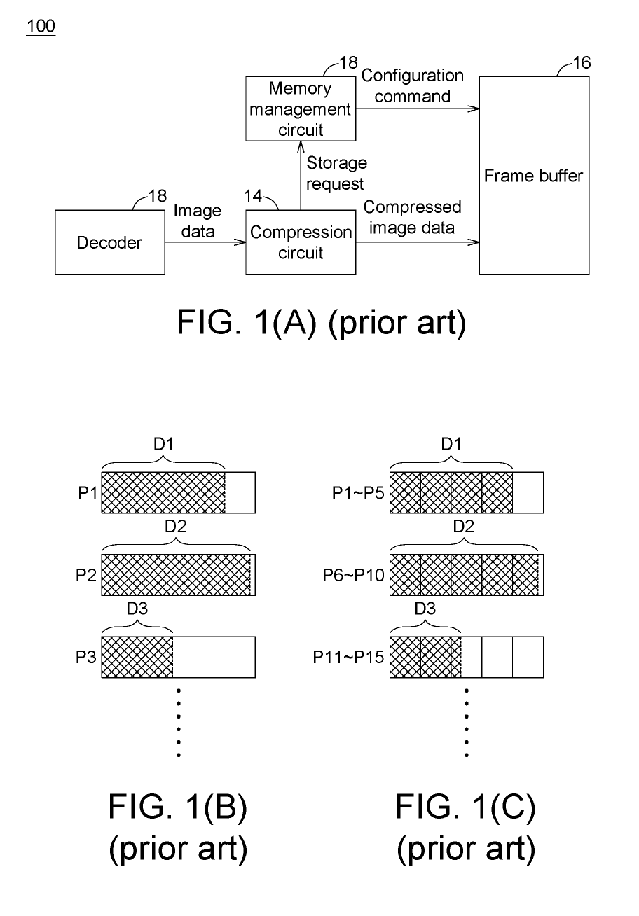

It should be noted that, the drawings of the present invention include functional block diagrams of multiple functional modules related to one another. These drawings are not detailed circuit diagrams, and connection lines therein are for indicating signal flows only. The interactions between the functional elements/or processes are not necessarily achieved through direct electrical connections. Further, functions of the individual elements are not necessarily distributed as depicted in the drawings, and separate blocks are not necessarily implemented by separate electronic elements.

### DETAILED DESCRIPTION OF THE INVENTION

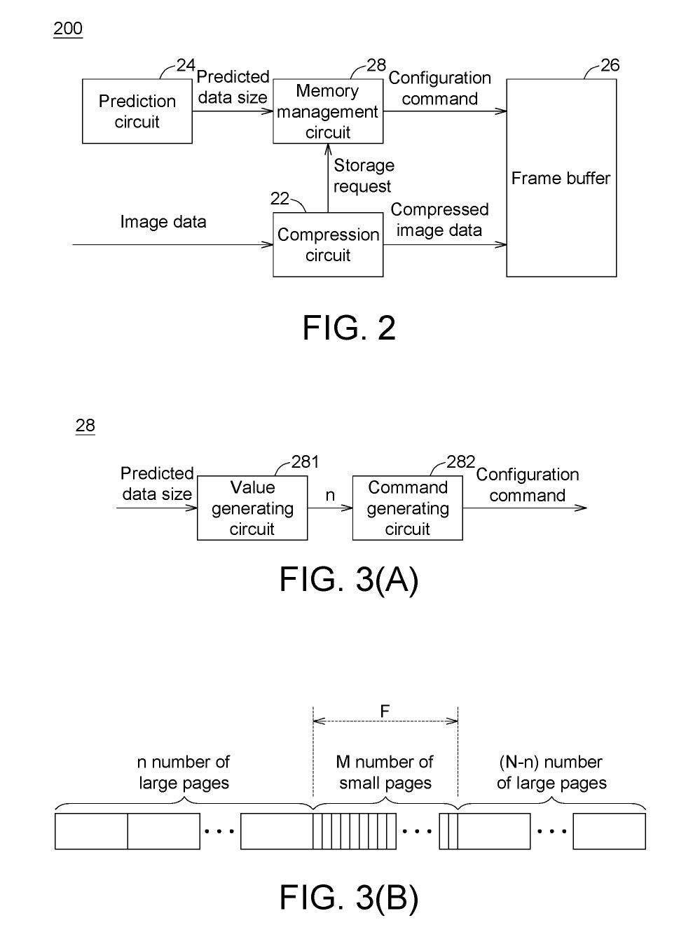

FIG. 2 shows a function block diagram of an image processing apparatus according to an embodiment of the present invention. An image processing apparatus 200 includes a compression circuit 22, a prediction circuit 24, a frame buffer 26 and a memory management circuit 28. In practice, the image processing apparatus 200 may be an independent unit, or may be integrated into various image processing systems (not limited to a transmitting end or a receiving end) that need compress image data and store compressed image data into a frame buffer. Functions of the circuits in the image processing apparatus 200 are described below.

The compression circuit 22 compresses image data to generate compressed image data. The image data may be from, for example but not limited to, a decoder in a digital image receiving end. It should be noted that, the scope of the present invention does not limit the compression mechanism adopted by the compression circuit 22. In this embodiment, while performing compression, the compression circuit 22 sequentially stores the compressed image data into the frame buffer 26. Thus, before outputting a new batch of compressed image data to the frame buffer 26, the compression circuit 22 requests the memory management circuit 28 to allocate available space to the compressed image data.

The storage request from the compression circuit 22 is also sent to the prediction circuit 24. In response to the storage request, the prediction circuit 24 generates a predicted data size for the compressed image data that is to be generated by the compression circuit 22. Taking a dynamic image for example, Time-adjacent frames have similarity in pixels to a certain extent and have similar data sizes. The prediction circuit 24 can use the compressed data size of a previous frame or use an average value of compressed data sizes of previous three frames as a predicted value of the compressed data size of the current frame. In practice, there are numerous methods for predicting the compressed data size generally known to one person skilled in the art, and the associated details shall be omitted herein. Further, implementation details of how the prediction circuit 24 generates the predicted data size do not form limitations on the scope of the present invention.

The frame buffer 26 is configured to include a plurality of large pages and a plurality of small pages. For example, the frame buffer 26 may be configured to include a plurality of large frames each having a 1 MB storage capacity, and a plurality of small pages each having a 128 KB storage capacity. The scope of the present invention is not limited to a specific storage mechanism, and the frame buffer 26 may include, for example but not limited to, a DDR SDRAM.

In response to the storage request from the compression circuit 22, the memory management circuit 28 allocates N number of large pages and M number of small pages in the frame buffer 26 for use of the compressed image data, where N and M are individually positive integers. In one embodiment, the values N and M are individually set to predetermined values, and are sufficient for handling a scenario of worst compression efficiency (i.e., a largest compressed data size). Assuming that with worst compression efficiency, the compressed data size of one frame is 7.125 MB. When the storage capacity of one large page is 1 MB and the storage capacity of one small page is 128 KB for example, a total storage capacity of 7.125 MB can be provided when the values N and M are respectively equal to 5 and 17. Alternatively, a total storage capacity of 7.125 MB can also be provided when the values N and M are respectively equal to 4 and 25. It should be noted that, the memory management circuit 28 can also determine the values N and M according to a remaining space in the frame buffer 26, with associated details to be described shortly.

The memory management circuit 28 determines, according to the predicted data size, an order of using the N number of large pages and the M number of small pages when the current batch of compressed image data is stored into the frame buffer 26. FIG. 3(A) shows a detailed example of the memory management circuit 28. A value generating circuit 281 generates a natural number n smaller than or equal to N according to the predicted data size provided by the prediction circuit 24. A command generating circuit 282 generates a configuration command according to the value n, demanding the frame buffer 26 to first use n number of large pages among the N number of large pages, M number of small pages, and then the remaining (N-n) number of large pages, when the frame buffer 26 stores the current batch of compressed image data into the frame buffer 26. FIG. 3(B) shows a schematic diagram of using the pages, which are used from the left end sequentially to the right.

The function of the value generating circuit 281 is to select an appropriate value n, such that after this batch of compressed data is completely stored into the frame buffer 26, the first n number of large pages are fully used and an ending point falls within a storage range F of the small pages, as shown in FIG. 3(B). Thus, the wasted space among these pages does not exceed at most the storage capacity of one small page. In other words, compared to prior art in which only large pages are used, having the ending point fall within the storage range F in FIG. 3(B) effectively reduces the waste of not fully using the pages. Further, because n number of large pages are first used, compared to prior art in which only small pages are used, the number of pages accessed for the same batch of compressed image data is smaller, thus reducing the access time as well as the total quantity of numbers of the pages.

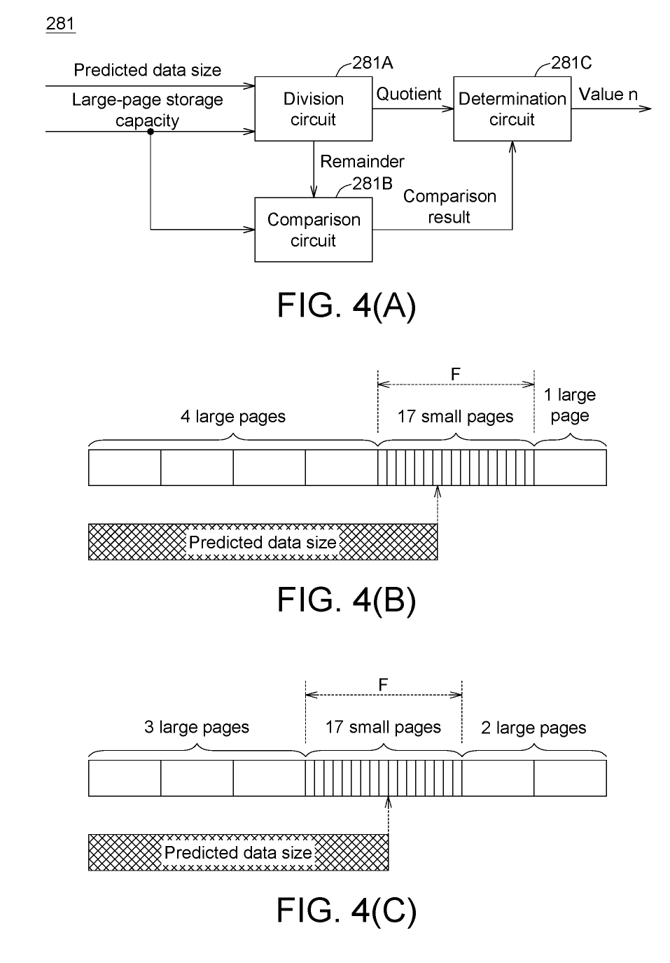

FIG. 4(A) is a detailed example of the value generating circuit 281 according to an embodiment. In this embodiment, the value M is set as a predetermined value in a way that the total storage capacity of total M number of small pages is substantially twice the storage capacity of one large page. When the storage capacitor of one large page is 1 MB and the storage capacity of one small page is 128 KB for example, defining the value M to equal to 16 satisfies the above ratio condition. Thus, the value M can be set to equal to 16, or integers such as 14, 15, 17 and 18 close to 16. A division circuit 281A divides the predicted data size by the storage capacity of one large page to obtain a quotient and a remainder. A comparison circuit 281B compares the remainder with half of the storage capacity of one large page. When the remainder is greater than half of the storage capacity of one large page, a determination circuit 281C sets the value n to equal to the quotient calculated by the division circuit 281A. On the other hand, when the remainder is smaller than half of the storage capacity of one large page, the determination circuit 281C sets the value n to equal to the quotient subtracted by one. In practice, the determination circuit 281C may include a multiplexer, which is controlled by a comparison result provided by the comparison circuit 281B to select one between two input signals (the quotient and the quotient subtracted by one) as an output signal n. For example, assuming that the predicted data size is 4.837 MB and the storage capacity of one large page is 1 MB, the division circuit 281A divides the former by the latter to obtain 4 as the quotient and 0.837 MB as the remainder. In the above example, the remainder 0.837 MB is greater than half of the storage capacity of one large page 0.5 MB, so the determination circuit 281C sets the value n to be equal to 4.

As previously described, the examples in FIG. 4(A) and FIG. 4(C) are assumed under a scenario of worst compression efficiency, where the worst compressed data size of one frame is 7.125 MB. In this example, assume that the memory management circuit 28 allocates five large pages and seventeen small pages to each batch of compressed image data (M=5 and N=17). FIG. 4(B) shows an order or using the pages corresponding to the above example, and the relation between the predicted data size (4.827 MB) and the storage capacity. Because the value n is equal to 4, the order of using the pages is four large pages, seventeen small pages and one large page. As shown in FIG. 4(B), before and after the storage position corresponding to the ending point of the predicted data size are left with some marginal spaces. Even if the actual data size differs from the predicted data size, given that the ending point of the actual data size falls within the storage range F, the first four large pages can be fully used, and the wasted space caused among the pages does not exceed at most the storage capacity of one small page.

FIG. 4(C) shows an example where the predicted data size is changed to 4.125 MB while the other conditions remain the same. In the above situation, because the remainder 0.125 MB is smaller than half of the storage capacity of one large page, the determination circuit 281C sets the value n to be equal to 3. Compared to the value n equal to 4, making the value n equal to 3 allows the end point of the predicted data size to be closer to middle point of the storage range F, and the probability that the ending point of the actual data size falls within the storage range F can be accordingly increased. From these two examples, the significance of proper arrangements of page order is clearly demonstrated. In comparison, in the conventional page arrangement the data is stored into five large pages, and for the same data amount, the fifth large page stores only 0.125 MB data, and thus the remaining 0.875 MB storage space is wasted.

In one embodiment, the value generating circuit 281 sets the value n to be not smaller than a threshold. For example, if the determination circuit 281C figures out that the value n determined originally according to the predicted data size is smaller than a threshold, the value n may be modified to be equal to the threshold, rather than using the quotient generated by the division circuit 281A or the quotient subtract by one. Taking the threshold equal to 3 for example, if the determination circuit 281C figures out that the value n determined originally according to the predicted data size is 0, 1 or 2, the final outputted value is modified to 3. This threshold is a value predetermined by a circuit designer. For example, assume that the predicted data size is 1.125 MB, the storage capacity of one large page is 1 MB and the storage space of one small page is 128 KB. The division circuit 281A obtains 1 as the quotient and 0.125 MB as the remainder. Because the remainder 0.125 MB is smaller than a half (0.5 MB) of the storage capacity of one large page, when no threshold is set, the determination circuit 281C sets the value n to equal to the quotient subtracted by one, i.e., 0, which means that the command generating circuit 282 demands the frame buffer 26 to first use seventeen small pages and then five large pages. In the above situation, if the actual data size of the compressed image data is 1.125 MB, the first nine small pages allocated to this batch of compressed image data are used. In contrast, if the threshold is set to equal 3, determination circuit 281C sets the value n to equal to 3, thus the command generating circuit 282 would demand the frame buffer 26 to first use three large pages, seventeen small pages and then the remaining two large pages in sequence. In the above situation, the compressed data image having an actual data size of 1.125 MB occupies the first two large pages, and the following small pages are not used at all. Comparing the two situations above, it is seen that, when a threshold is set, even if the storage space of the second large page is not at all used, the total number of pages that need to be accessed for the same batch of compressed image data can be significantly reduced (from nine to two in this case), achieving enhanced overall operation efficiency.

Assume that the compressed data size of one frame is known to be 7.125 MB in a scenario with worst compression efficiency. It is observed from the foregoing paragraphs that, when the value n determined according to the predicted data size is smaller than the threshold (3), the actual data size is very likely far lower than 7.125 MB. From an overall perspective of the frame buffer 26, a total storage space used by this batch of compressed image data is in fact not large. Thus, even if the storage space of one large page is not fully used, the space wasted is tolerable.

It should be noted that, the scope of the present invention is not limited to a situation where the frame buffer includes pages having two different sizes. An example is given below.

In one embodiment, the frame buffer 26 is designed to include a plurality of large pages, a plurality of medium pages and a plurality of small pages. For example, the frame buffer 26 includes a plurality of large pages each having a 1 MB storage capacity, a plurality of medium pages each having a 128 KB storage space, and a plurality of small pages each having a 16 KB storage space. In this embodiment, in response to a storage request issued by the compression circuit 22, the memory management circuit 28 further allocates, in addition to the N number of large pages and the M number of small pages, P number of medium pages for the compressed image data to use, where P is a positive integer. The design of the additional medium pages apart from the large pages and the small pages enhances the allocation flexibility of the memory management circuit 28, further reducing the possible storage space waste. Similarly, the memory management circuit 28 determines, according to the predicted data size, the order of using the N number of large pages, the P number of medium pages and the M number of small pages.

In one embodiment, the values N, P and M are individually set as predetermined values, and are sufficient for handling a scenario with worst compression efficiency. Assume that the compressed data size of one frame is known to be 7.125 MB in a scenario with worst compression efficiency.

When the storage capacity of one large page is 1 MB, the storage capacity of one medium page is 128 KB and the storage capacity of one small page is 16 KB, by setting the values N, P and M to be 5, 15 and 16, respectively, a total storage capacity of 7.125 MB can be provided. It should be noted that, the memory management circuit 28 can also in real time determines the values N, P and M according to a total remaining space in the frame buffer 26. Associated details are given below.

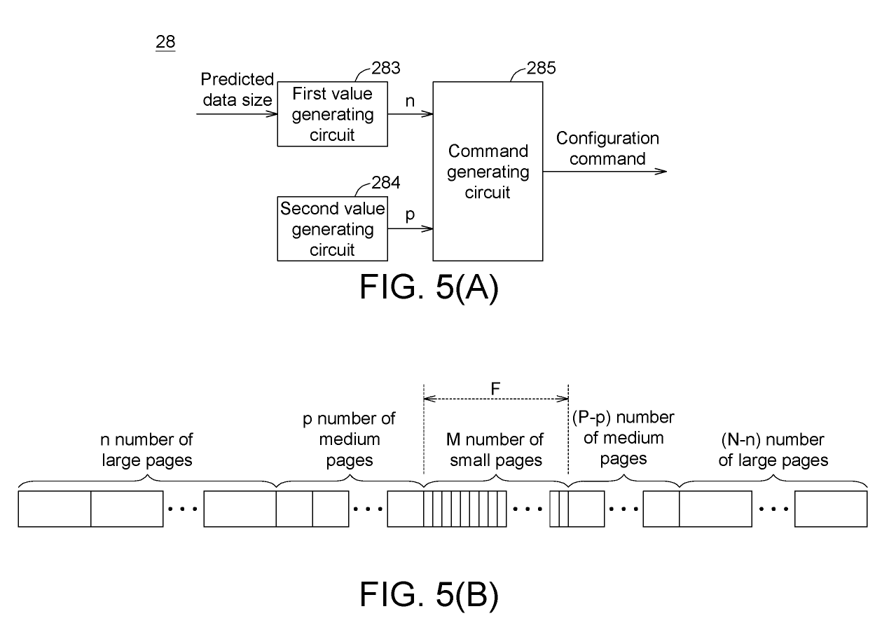

FIG. 5(A) shows a detailed example of the memory management circuit 28 cooperating with pages having three different storage capacities according to an embodiment. A first value generating circuit 283 generates a natural number n smaller than or equal to N according to the predicted data size. A second value generating circuit 284 generates a natural number p smaller than or equal to P according to the predicted data size. A command generating circuit 285 generates a configuration command according to the value n and the value p, demanding the frame buffer 26 to sequentially use, when the compressed image data is stored into the frame buffer 26, n number of large pages, p number of medium pages, M number of small pages, and (P-p) medium pages, (N-n) number of large pages. FIG. 5(B) shows a schematic diagram of using these pages.

Similarly, functions of the first value generating circuit 283 and the second value generating circuit 284 are to select appropriate values n and p, such that, after the entire batch of compressed image data is stored into the frame buffer 26, the first n number of large pages and the p number of medium pages are fully used, and the ending point falls within the storage range F provided by the small pages in FIG. 5(B).

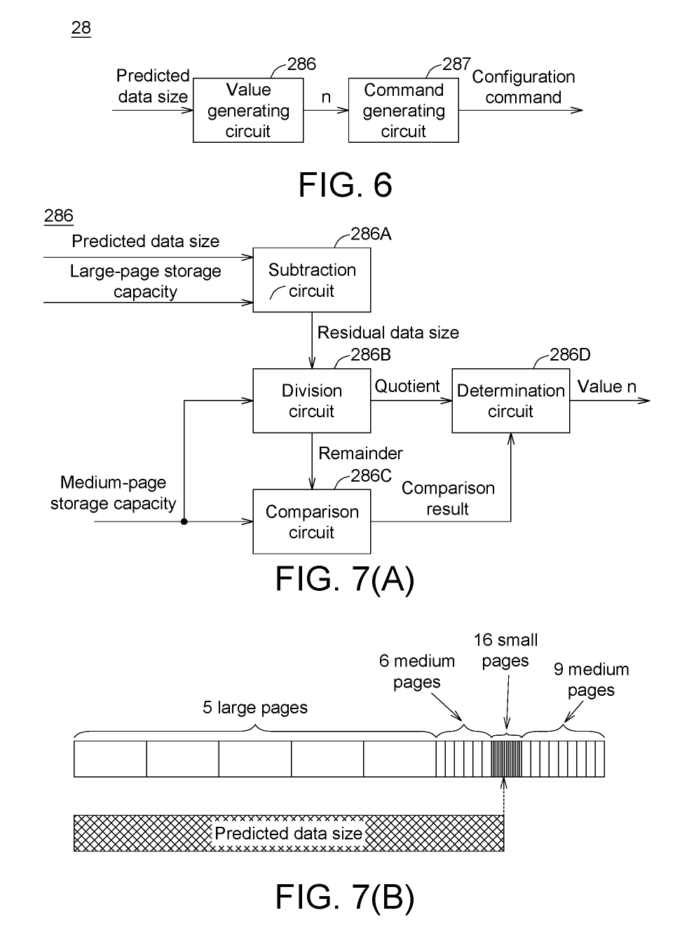

FIG. 6 shows a detailed example of the memory management circuit 28 according to another embodiment. In this embodiment, the memory management circuit 28 includes a value generating circuit 286 and a command generating circuit 287. More specifically, the value n in this embodiment is set constant to be equal to the value N, and the first value generating circuit 283 in FIG. 5(A) is not needed. The value generating circuit 286 generates a natural number p smaller than or equal to P. The command generating circuit 287 generates a configuration command according to the value p, demanding the frame buffer 26 to sequentially use, when the compressed image data is stored into the frame buffer 26, N number of large pages, p number of medium pages, M number of small pages and (P-p) number of medium pages. This concept is similar to setting the value n to be not smaller than a threshold as previously described. In the embodiment in FIG. 6, the threshold is N.

FIG. 7(A) shows a detailed example of the value generating circuit 286 according to an embodiment. In this embodiment, the value M is predetermined in a way that the total storage capacity provided by M number of small pages is substantially equal to twice the storage capacity of one medium page. When the storage capacity of one medium page is 128 KB and the storage capacity of one small page is 16 KB for example, setting the value M to be equal to 16 satisfies the above ratio condition. Thus, the value M may be set to be equal to 16, or an integer 14, 15, 17 or 18 that is close to 16. A subtraction circuit 286A subtracts N times the storage capacity of one large page from the predicted data size to generate a residual data size. A divider circuit 286B divides the remaining data size by the storage capacity of one medium page to obtain a quotient and a remainder. A comparison circuit 286C compares the remainder with a half of the storage space of one medium page. When the remainder is greater than a half of the storage capacity of one medium page, a determination circuit 286D sets the value p to be equal to the quotient; when the remainder is smaller than a half of the storage capacity of one medium page, the determination circuit 286D sets the value p to be equal to the quotient subtracted by one. Assume that the memory management circuit 28 in total allocates five 1 MB large pages (M=5), fifteen 128 KB medium pages (P=15) and sixteen 16 KB small pages (N=16) to each batch of compressed image data. When the predicted data size is 5.837 MB, the residual data size is 0.837 MB, and the divider circuit 286D calculates the quotient to be 6 and the remainder to be 0.696 (in a unit of 128 KB). Thus, the remainder is in fact 89 KB. Because the remainder is greater than a half (64 KB) of the storage capacity of one medium page, the determination circuit 286D sets the value p to be equal to 6. FIG. 7(B) shows an order of using the pages corresponding to the above example, and the relation between the predicted data size (5.837 MB) and the storage space. The concept of this embodiment is similar to the concepts in FIG. 4(B) and FIG. 4(C), i.e., making the ending point of the predicted data size to be close to the middle point of the storage range contributed by the small pages.

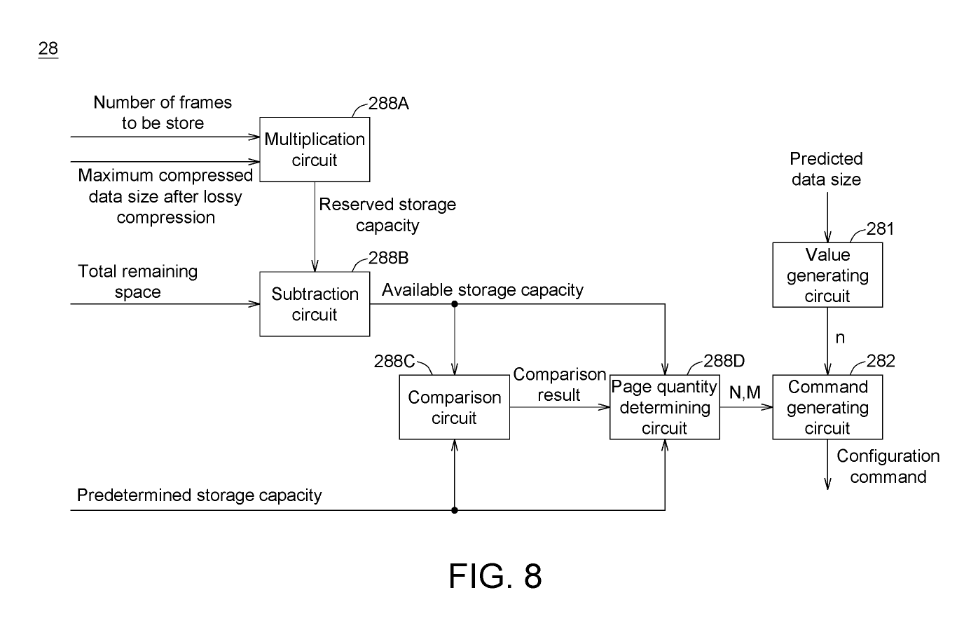

It is previously mentioned that, the memory management circuit 28 can determine the values N and M according to the total remaining space in the frame buffer 26. In one embodiment, the total capacity of the frame buffer 26 is 64 MB, and is configured to simultaneously accommodate compressed image data of ten frames. If a maximum compressed data size of one frame processed by lossless compression is 7.125 MB, it is possible the frame buffer 26 may not accommodating the total ten batches of lossless compressed image data (71.25 MB>64 MB). When the storage space may become inadequate, the memory management circuit 28, by adjusting and controlling the values N and M in real time, can attempt to achieve the goal of simultaneously accommodating the ten batches of compressed image data as much as possible. FIG. 8 shows a detailed example of the memory management circuit 28 according to an embodiment of the present invention. The memory management circuit 28 in FIG. 8 is a variation of the memory management circuit 28 in FIG. 3(A). In addition to the value n generated by the value generating circuit 281, the command generating circuit 282 generates the configuration command further according to the values N and M provided by a page quantity determining circuit 288D, with associated details given below.

A combination of a multiplication circuit 288A and a subtraction circuit 288B in FIG. 8 calculates an available space for compressed image data of one frame to be soon stored. More specifically, the multiplication circuit 288A calculates a product of two values below as a reserved storage capacity: (1) the quantity of frames not yet stored into the frame buffer 26 subtracted by one; and (2) a maximum compressed data size of one frame processed by lossy compression. The reserved storage capacity represents a maximum storage space needed for subsequent sets of compressed data in a worst scenario (where lossy compression is adopted). For example, if the data frame 26 already stores compressed image data of six frames, the quantity of frames not yet stored into the frame buffer is four. Assume that the maximum compressed data size of one frame processed by lossy compression is 4 MB, the multiplication circuit 288A calculates the reserved storage capacity as 12 MB (=(4−1)*4 MB). In practice, the maximum compressed data size after lossy compression may be learned experimentally in advance, and is a constant value provided to the multiplication circuit 288A. The reserved data size may change as the quantity of frames to be stored changes.

The subtraction circuit 288B subtracts the reserved storage capacity generated by the multiplication circuit 288A from the current total remaining space to generate an available storage capacity. For example, assuming that the six frames stored in the frame buffer have occupied a 42 MB storage space, the total remaining space is 24 MB. By subtracting the 12 MB reserved storage capacity from the 24 MB total remaining space, the subtraction circuit 288B calculates the available storage capacity to be 12 MB. More specifically, the calculated available storage capacity represents the storage space available for subsequent lossy compression after the compressed image data of the current frame is stored.

The comparison circuit 288C compares the available storage capacity with a predetermined storage capacity. The predetermined storage capacity corresponds to a predetermined compression method adopted at the time when the compression circuit 22 generates compressed image data. For example, the compression method may be lossless compression, and the predetermined storage capacity may be a maximum compressed data size of one frame having undergone lossless compression (e.g., 7.125 MB in the foregoing example). The page quantity determining circuit 288D determines the values N and M according to the comparison result of the comparison circuit 288C. When the available storage capacity is greater than the predetermined storage capacity, it means that even if the seventh frame is stored in a lossless-compressed form, the current total remaining space is sufficient for storing the three subsequent frames in a lossy-compressed form. Thus, the page quantity determining circuit 288D determines the values N and M according to the predetermined storage capacity (7.125 MB). As such, it is beneficial that the seventh frame is under lossless compression rather than lossy compression. For example, if the storage capacities of one large page and one small page are 1 MB and 128 KB, respectively, the page quantity determining circuit 288D sets the values N and M to be 5 and 17, respectively.

Each time before pages are allocated to the compressed image data of one frame, the memory management circuit 28 would check the current available storage capacity of the frame buffer 26. When the available storage capacity is smaller than the predetermined storage capacity, it is not feasible to allocate pages according to the data size of lossless compression, otherwise it may cause insufficient storage space for the compressed image data of subsequent frames even if lossy compressions are performed. When the available storage capacity is smaller than the predetermined storage capacity, the page quantity determining circuit 288D determines the values N and M according to the available storage capacity instead. For example, assuming that the compressed image data of seven frames already stored in the frame buffer 26 occupies a 49 MB storage space in the frame buffer 26, the total remaining space is 15 MB, and for the eighth frame the available storage capacity is 7 MB (=15−2*4). Because the available storage capacity is smaller than the predetermined storage capacity (7.125 MB), the page quantity determining circuit 288D determines the values N and M according to the available storage capacity instead; that is, the page quantity determining circuit 288D chooses the values N and M in a way that the total storage capacity of N number of large pages and M number of small pages is equal to 7 MB (e.g., N=5 and M=16). Thus, in the frame buffer 26, sufficient space is reserved for storing compressed image data of the last two frames in a lossy-compressed form.

When the available storage capacity is smaller than the predetermined storage capacity, apart from adjusting the values N and M, the memory management circuit 28 also notifies the compression circuit 22 to perform lossy compression on the current frame. Further, at the meantime, the configuration command generated by the command generating circuit 282 includes demanding that the N number of large pages are used prior to the M number of small pages.

One person skilled in the art can understand that, the concept of determining the values N and M according to the total remaining space in the frame buffer 26 is not limited to being applied to pages having two different sizes; for example, the values N, P and M can be adjusted according to the total remaining space in a situation of pages having three different sizes.

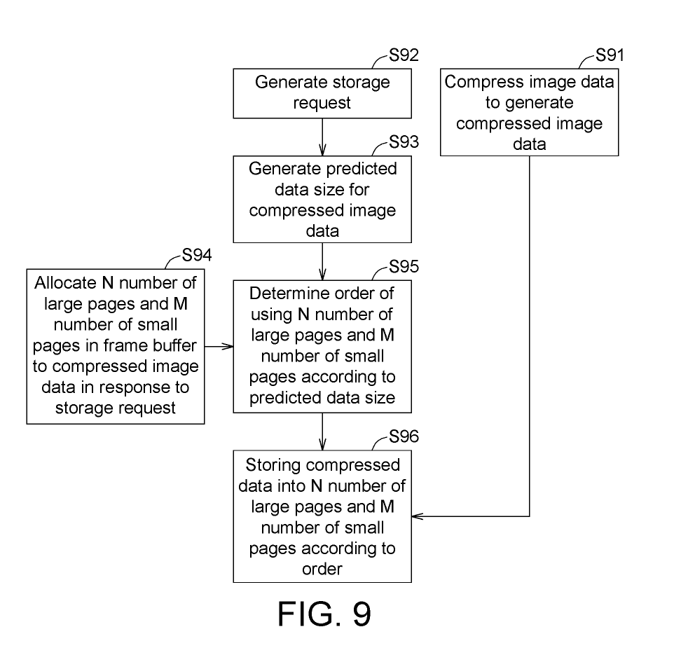

An image data processing method cooperating with a frame buffer is further provided according to another embodiment of the present invention. FIG. 9 shows a flowchart of the image data processing method. The frame buffer is configured to include a plurality of large pages and a plurality of small pages. In step S91, image data is compressed to generate compressed image data. In step S92, a storage request of storing the compressed image data into the data frame is generated. In response to the storage request, steps S93 and S94 are performed. In step S93, a predicted data size of the compressed image data is generated. In step S94, N number of large pages and M number of small pages in the frame buffer are allocated to the compressed image data, where N and M are individually positive integers. In step S95, an order of using the N number of large pages and the number of M small pages is determined according to the predicted data size when the compressed image data is stored into the frame buffer. In step S96, the compressed image data is stored into the frame buffer according to the order.

One person can understand that, operation variations in the description associated with the image processing apparatus 200 are applicable to the image data processing method in FIG. 9, and shall be omitted herein.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An image processing apparatus, comprising:
a frame buffer, configured to comprise a plurality of large pages and a plurality of small pages;
a compression circuit, compressing image data to generate compressed image data, and generating a storage request of storing the compressed image data into the frame buffer;
a prediction circuit, generating a predicted data size for the compressed image data in response to the storage request; and
a memory management circuit, allocating N number of large pages and M number of small pages to the compressed image data in response to the storage request;
wherein, when the compressed image data is stored into the frame buffer, the memory management circuit determines an order of using the N number of large pages and the M number of small pages according to the predicted data size, where N and M are individually positive integers.

2. The image processing apparatus according to claim 1, wherein the memory management circuit comprises:
a value generating circuit, generating a natural number n according to the predicted data size, n being smaller than or equal to N; and
a command generating circuit, generating a configuration command according to the value n, demanding that, when the compressed image data is stored into the frame buffer, the order of using the N number of large pages and the M number of small pages is: n number of large pages among the N number of large pages, the M number of small pages, and the remaining (N-n) number of large pages, in sequence.

3. The image processing apparatus according to claim 2, wherein each of the large pages is configured to provide a large-page storage capacity, the value M is set as a predetermined value such that a total storage capacity of the total M number of small pages is substantially twice the large-page storage capacity, and the value generating circuit comprises:
a division circuit, calculating a quotient and a remainder of dividing the predicted data size by the large-page storage capacity;
a comparison circuit, comparing the remainder with a half of the large-page storage capacity; and
a determination circuit, determining the value n to be equal to the quotient when the remainder is greater than a half of the large-page storage capacity, and determining the value n to be equal to the quotient subtracted by one when the remainder is small than a half of the large-page storage capacity.

4. The image processing apparatus according to claim 2, wherein the value generating circuit sets the value n to be not smaller than a threshold, and the threshold is a positive integer smaller than N.

5. The image processing apparatus according to claim 1, wherein the frame buffer further comprises a plurality of medium pages in addition to the plurality of large pages and the plurality of small pages; and in response to the storage request , the memory management circuit further allocates, apart from the N number of large pages and the M number of small pages, P number of medium pages in the frame buffer for use of the compressed image data, and determines, according to the predicted data size, an order of using the N number of large pages, the M number of small pages and the P number of medium pages when the compressed image data is stored into the frame buffer, where P is a positive integer.

6. The image processing apparatus according to claim 5, wherein the memory management circuit comprises:
a first value generating circuit, generating a natural number n smaller than or equal to N according to the predicted data size;
a second value generating circuit, generating a natural number p smaller than or equal to P according to the predicted data size; and
a command generating circuit, generating a configuration command according to the value n and the value p, demanding that, when the compressed image data is stored into the frame buffer, the order of using the N number of large pages, the M number of small pages and the P number of medium pages is: n number of large pages among the N number of large pages, p number of medium pages among the P number of medium pages, the M number of small pages, the remaining (P-p) number of medium pages, and the remaining (N-n) number of large pages, in sequence.

7. The image processing apparatus according to claim 5, wherein the memory management circuit comprises:
a value generating circuit, generating a natural number p smaller than or equal to P according to the predicted data size; and
a command generating circuit, generating a configuration command according to the value p, demanding that, when the compressed image data is stored into the frame buffer, the order of using the N number of large pages, the M number of small pages and the P number of medium pages is: the N number of large pages, p number of medium pages among the P number of medium pages, the M number of small pages, and the remaining (P-p) number of medium pages, in sequence.

8. The image processing apparatus according to claim 7, wherein each of the large pages is configured to provide a large-page storage capacity, each of the medium pages is configured to provide a medium-page storage capacity, the value M is predetermined such that the M number of small pages provide a total storage capacity twice the medium-page storage capacity, and the value generating circuit comprises:
a subtraction circuit, subtracting N times the large-page storage capacity from the predicted data size to generate a residual data size;
a division circuit, calculating a quotient and a remainder of dividing the residual data size by the medium-page storage capacity;
a comparison circuit, comparing the remainder with a half of the medium-page storage capacity; and
a determination circuit, determining the value p to be equal to the quotient when the remainder is greater than a half of the medium-page storage capacity, and determining the value p to be equal to the quotient subtracted by one when the remainder is smaller than a half of the medium-page storage capacity.

9. The image processing apparatus according to claim 5, wherein the values N, P and M are individually predetermined values.

10. The image processing apparatus according to claim 1, wherein the memory management circuit comprises:
a subtraction circuit, subtracting a reserved storage capacity from a total remaining space in the frame buffer to generate an available storage capacity, wherein the reserved storage capacity is reserved for subsequent compressed image data;
a comparison circuit, comparing the available storage capacity with a predetermined storage capacity, wherein the predetermined storage capacity is determined from a maximum compressed data size of the compressed image data with a predetermined compression method;
a page quantity determining circuit, determining the value N and the value M according to the predetermined storage capacity when the available storage capacity is greater than the predetermined storage capacity, and determining the value N and the value M according to the available storage capacity when the available storage capacity is smaller than the predetermined storage capacity; and
a command generating circuit, generating a configuration command when the available storage capacity is smaller than the predetermined storage capacity, demanding that the order of using the N number of large pages and the M number of small pages is sequentially the N number of large pages and the M number of small pages.

11. An image data processing method for cooperating with a frame buffer, the frame buffer configured to comprise a plurality of large pages and a plurality of small pages, the image data processing method comprising:
a) compressing image data to generate compressed image data, and generating a storage request of storing the compressed image data into the frame buffer;
b) generating a predicted data size for the compressed image data in response to the storage request;
c) allocating N number of large pages and M number of small pages in the frame buffer to the compressed image data in response to the storage request, where N and M are individually positive integers;
d) determining an order to using the N number of large pages and the M number of small pages according to the predicted data sizes; and
e) storing the compressed image data into the frame buffer according to the order.

12. The image data processing method according to claim 11, wherein step (d) comprises:
d1) generating a natural number n according to the predicted data size, n being smaller than or equal to N; and
d2) demanding that, when the compressed image data is stored into the frame buffer, the order of using the N number of large pages and the M number of small pages is: n number of large pages among the N number of large pages, the M number of small pages, and the remaining (N-n) number of large pages, in sequence.

13. The image data processing method according to claim 12, wherein each of the large pages is configured to provide a large-page storage capacity, the value M is set as a predetermined value such that a total storage capacity of the total M number of small pages is substantially twice the large-page storage capacity, and step (d1) comprises:
calculating a quotient and a remainder of dividing the predicted data size by the large-page storage capacity;
comparing the remainder with a half of the large-page storage capacity; and
setting the value n to be equal to the quotient when the remainder is greater than a half of the large-page storage capacity; and
setting the value n to be equal to the quotient subtracted by one when the remainder is small than a half of the large-page storage capacity.

14. The image data processing method according to claim 12, wherein step (d1) comprises setting the value n to be not smaller than a threshold, and the threshold is a positive integer smaller than N.

15. The image data processing method according to claim 11, wherein the frame buffer is configured to further comprise a plurality of medium pages in addition to the plurality of large pages and the plurality of small pages; step (c) further comprises allocating P number of medium pages in the frame buffer for use of the compressed image data, where P is a positive integer; and step (d) further comprises determining, according to the predicted data size, an order of using the N number of large pages, the M number of small pages and the P number of medium pages when the compressed image data is stored into the frame buffer.

16. The image data processing method according to claim 15, wherein step (d) comprises:
generating a natural number n smaller than or equal to N according to the predicted data size;
generating a natural number p smaller than or equal to P according to the predicted data size; and
demanding that, when the compressed image data is stored into the frame buffer, the order of using the N number of large pages, the M number of small pages and the P number of medium pages is:n number of large pages among the N number of large pages, p number of medium pages among the P number of medium pages, the M number of small pages, the remaining (P-p) number of medium pages, and the remaining (N-n) number of large pages, in sequence.

17. The image data processing method according to claim 15, wherein step (d) comprises:
d1) generating a natural number p smaller than or equal to P according to the predicted data size; and
d2) demanding that, when the compressed image data is stored into the frame buffer, the order of using the N number of large pages, the M number of small pages and the P number of medium pages is: the N number of large pages, p number of medium pages among the P number of medium pages, the M number of small pages, and the remaining (P-p) number of medium pages, in sequence.

18. The image data processing method according to claim 17, wherein each of the large pages is configured to provide a large-page storage capacity, each of the medium pages is configured to provide a medium-page storage capacity, the value M is predetermined such that the M number of small pages provide a total storage capacity twice the medium-page storage capacity, and step (d1) comprises:
subtracting N times the large-page storage capacity from the predicted data size to generate a residual data size;
calculating a quotient and a remainder of dividing the residual data size by the medium-page storage capacity;
setting the value p to be equal to the quotient when the remainder is greater than a half of the medium-page storage capacity; and
setting the value p to be equal to the quotient subtracted by one when the remainder is smaller than a half of the medium-page storage capacity.

19. The image data processing method according to claim 15, wherein the values N, P and M are individually predetermined values.

20. The image data processing method according to claim 11, further comprising:
subtracting a reserved storage capacity from a total remaining space in the frame buffer to generate an available storage capacity, wherein the reserved storage capacity is reserved for subsequent compressed image data;
comparing the available storage capacity with a predetermined storage capacity, wherein the predetermined storage capacity is determined from a maximum compressed data size of the compressed image data with a predetermined compression method;
determining the value N and the value M according to the predetermined storage capacity when the available storage capacity is greater than the predetermined storage capacity; and
determining the value N and the value M according to the available storage capacity when the available storage capacity is smaller than the predetermined storage capacity, and demanding that the order of using the N number of large pages and the M number of small pages is sequentially the N number of large pages and the M number of small pages.
